(19) United States
(12) Patent Application Publication
(10) Pub. No.: US 2016/0211041 A1
(43) Pub. Date: Jul. 21, 2016

(54) PRODUCTION OF THERMAL ENERGY AND RADIOACTIVE SPECIES

(71) Applicant: Thomas C. Maganas, Manhattan Beach, CA (US)

(72) Inventor: Thomas C. Maganas, Manhattan Beach, CA (US)

(21) Appl. No.: 14/996,084

(22) Filed: Jan. 14, 2016

Related U.S. Application Data
(60) Provisional application No. 62/103,951, filed on Jan. 15, 2015.

(51) Int. Cl. G21G 1/02

(52) U.S. Cl. CPC G21G 1/02

(57) ABSTRACT

A power generation system for converting organic fuel into thermal energy and electric power. A reaction of organic fuel with highly reactive species generated from a catalytic media of suspended silica particles induces an enhanced exothermic reaction within a reaction chamber. The enhanced exothermic reaction enables greater power output, ensures complete combustion, and reduces or eliminates the requirement for input heat or energy to sustain the exothermic degradation of the organic materials. The enhanced exothermic reaction results in the emanation of ionizing radiation.

### CROSS-REFERENCE TO RELATED APPLICATIONS

This application claims the benefit of U.S. Provisional Patent Application No. 62/103,951, filed Jan. 15, 2015, the disclosure of which is incorporated herein in its entirety.

### BACKGROUND OF THE INVENTION

1. Field of the Invention

The invention is in the field of using organic materials, such as organic fossil fuels, coal, biomass, medical waste, municipal organic waste, and other organic wastes to generate heat, electrical energy, and radioactive particles.

2. Review of Technology

Conventional electric energy production from organic materials relies on combustion of such materials into their combustion products and cogeneration of heat, which is used to boil water that drives a turbine. The turbine, in turn, drives an electric generator for producing electric power. Electric energy can also be provided by fuel cells, which convert simple organic molecules into CO₂ and water. The oxidation-reduction reaction concomitantly provides electrical power that can be used for a desired purpose. In most cases, conventional combustion of organic materials creates significant pollutants, which are emitted into the atmosphere. Additionally, the full potential of harvestable energy from such organic feed materials is rarely realized due to problems such as process inefficiencies, incomplete combustion, low feedstock reactivity, and high input energy required to sustain sufficient reaction temperature.

In answer to the need to reduce emissions and more efficiently extract energy from organic materials, and to better sustain heat energy production while taking place, a reactor system was recently developed for efficiently transforming organic materials, such as organic waste, medical waste, coal and other fossil fuels, and biomass, into thermal energy with close to zero emission of pollutants. Such system is described in U.S. Pat. No. 8,283,512, U.S. Pat. No. 8,512,215, and U.S. Pat. No. 8,512,644, the disclosures of which are incorporated herein by reference.

### BRIEF SUMMARY

The present invention relates to methods and systems for transforming organic waste, medical waste, coal, fossil fuels, biomass, and other organic materials into thermal energy and electric power, with generation of radioactive particles. The methods and systems utilize a catalytic media, such as silica or alumina, to generate a highly reactive environment. The highly reactive environment can include dust plasma, wherein at least a portion of the gas is ionized, and can include the generation of localized electrostatic fields. The highly reactive environment can produce highly reactive species, including hydroxyl radicals, heavy electrons, ions, and other reactive species. The highly reactive species can efficiently convert an organic fuel heated within a reaction chamber of a reactor system into thermal energy. The highly reactive species further enable efficient conversion of organic fuel into thermal energy by inducing an enhanced exothermic reaction, such as by promoting or initiating a radioactive decay reaction.

An enhanced exothermic reaction provides self-sustaining energy for driving the reaction during degradation and reaction of organic materials in the reaction chamber, thereby increasing energy output, enabling complete combustion of organic materials in the reaction chamber, and eliminating the need for additional heat or energy input to sustain the exothermic degradation of organic materials driving the generation of thermal energy.

In certain embodiments, an enhanced exothermic reaction is the result of conditions within the reaction chamber caused by the interaction of the highly reactive species with organic materials in the reaction chamber. In certain embodiments, the highly reactive environment within the reactor may induce an enhanced reaction. An enhanced exothermic reaction may include a decay reaction resulting in the output of thermal energy as well as alpha particles, beta particles, and/or gamma radiation, particularly beta particles. Additionally, the reactive environment within the reactor can produce the radicals, heavy electrons, and other species capable of promoting the enhanced exothermic reaction.

These and other embodiments and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a perspective view of an embodiment of a reactor configured to generate thermal energy and radioactive species;

FIG. 2 is a perspective view of another embodiment of a reactor configured to generate thermal energy and radioactive species;

FIG. 3 is a cross-sectional view of a reactor configured to generate thermal energy and radioactive species;

FIG. 4A is a magnified view of the surface of a tungsten sample before treatment in a reactor;

FIG. 4B graphically illustrates SEM/EDS analysis of the tungsten sample shown in FIG. 4A before treatment in a reactor;

FIG. 4C is a magnified view of the surface of the tungsten sample after treatment in a reactor;

FIG. 4D graphically illustrates SEM/EDS analysis of the tungsten sample shown in FIG. 4C after treatment in a reactor;

FIG. 5A is a magnified view of the surface of a molybdenum sample before treatment in a reactor;

FIG. 5B graphically illustrates SEM/EDS analysis of the molybdenum sample shown in FIG. 5A before treatment in a reactor;

FIG. 5C is a magnified view of the surface of the molybdenum sample after treatment in a reactor;

FIG. 5D graphically illustrates SEM/EDS analysis of the molybdenum sample shown in FIG. 5C after treatment in a reactor;

FIG. 6A is a magnified view of the surface of a galvanized wire sample before treatment in a reactor;

FIG. 6B graphically illustrates SEM/EDS analysis of the galvanized wire sample shown in FIG. 6A before treatment in a reactor;

FIG. 6C is a magnified view of the surface of the galvanized wire sample after treatment in a reactor;

FIG. 6D graphically illustrates SEM/EDS analysis of the galvanized wire sample shown in FIG. 6C after treatment in a reactor;

FIG. 6E is another magnified view of the surface of the galvanized wire sample at another point of analysis after treatment in a reactor;

FIG. 6F graphically illustrates SEM/EDS analysis of the galvanized wire sample shown in FIG. 6E after treatment in a reactor;

FIG. 7A is a magnified view of the surface of an iron steel sample before treatment in a reactor;

FIG. 7B graphically illustrates SEM/EDS analysis of the iron steel sample shown in FIG. 7A before treatment in a reactor;

FIG. 7C is a magnified view of the surface of the iron steel sample after treatment in a reactor;

FIG. 7D graphically illustrates SEM/EDS analysis of the iron steel sample shown in FIG. 7C after treatment in a reactor; and

FIG. 8 graphically illustrates the relationship between measured temperature within a reaction chamber of a reactor and the net radiation emitted from the reactor.

### DETAILED DESCRIPTION OF THE PREFERRED EMBODIMENTS

### I. Introduction

The present disclosure relates to methods and systems for efficient conversion of fuels (e.g., coal, oil, natural gas, other fossil fuels, biomass, plant or mineral oils, municipal waste, and/or biological waste), into thermal energy using a thermal reactor configured to generate an enhanced exothermic reaction. The methods and systems utilize a catalytic media, such as silica or alumina, to generate ionized gas, highly reactive hydroxyl radicals and protons (e.g., resulting from the splitting of water), heavy electrons, and other reactive species in the presence of organic fuel heated to pyrolysis to efficiently convert the fuel into heat and electromagnetic energy.

The highly reactive species further enable efficient conversion of the organic material fuel into heat and electromagnetic energy by inducing an enhanced exothermic reaction, such as by initiating a decay reaction. Such conversion may be carried out in a single reaction chamber or multiple reaction chambers, at a relatively constant temperature range, and in a one-step process. This allows for the efficient conversion of organic materials into heat energy without the attendant problems of high temperature formation of NOₓ and SOₓ typically produced during high temperature combustion of organic materials.

The terms “activate” and “activated” are meant to refer a condition in which the catalytic media (e.g., silica and/or alumina particles) are able to produce a “reactive environment” of ionized gas, highly reactive hydroxyl radicals and protons (e.g., resulting from the splitting of water), heavy electrons, and other reactive species capable of degrading and extracting heat and electromagnetic energy from organic material, such as a carbon-containing fuel or biological waste.

The term “reactive environment” is meant to refer to the condition within the reaction chamber, and possibly surrounding areas and conduits, which includes a localized concentration of highly reactive species.

The term “reactive species” is meant to refer to ionized gas, highly reactive hydroxyl radicals and protons (e.g., resulting from the splitting of water), heavy electrons, and other reactive species that further the degradation of organic fuels and/or that initiate or promote an enhanced exothermic reaction.

The terms “organic fuel,” “organic materials,” “carbon-containing fuel,” “organic fuel material,” “biological materials”, and the like are meant to refer to carbon containing materials suitable for use as a fuel source within one or more of the thermal reactors disclosed herein. Examples include biomass (e.g., plant materials, green waste, etc.), fossil fuels, medical waste, and municipal waste (e.g., commingled municipal waste, papers, plastics, rubber, etc.). The terms are meant to refer to any organic material that generate and/or release energy when combusted or burned, usually in the form of heat, light or a combination thereof. The term “fossil fuel” is a subset of “carbon-containing fuel” and includes coal, oil, natural gas, derivatives of coal, natural gas and oil, and the like. Non-fossil organic fuels include alcohols, fuels derived from alcohols or other fermentation products, wood, biomass and the like. In some embodiments, a liquid fuel such as natural gas is used to fuel the thermal reactor and to generate an enhanced exothermic reaction. Additionally, or alternatively, one or more organic materials are delivered to the interior of a thermal reactor to drive the operation of the reactor.

The term “reaction chamber” shall be broadly construed to include any apparatus capable of holding therein a catalytic media, such as silica and/or alumina, and that provides appropriate conditions that result in formation of the reactive atmosphere for degrading and converting organic materials into heat and electromagnetic energy.

The terms “degrade” or “degradation” refer to processes by which organic materials or incomplete combustion products such as soot, hydrocarbons, CO, tissues, cells, biological fluids, and oily substances are at least partially broken down or eliminated to yield lesser organic substances. It includes complete combustion of gases into carbon dioxide, water and other clean reaction products. It also includes any reaction in which CO, CO₂, carbon or hydrocarbons are converted into other, less polluting forms of carbon or other substances.

The term “suspended” is meant to indicate that at least a portion of the catalytic particles are slightly elevated and/or separated by rising gases such that they are not at rest in a state of natural particle packing density. Suspending the particles leaves them in a less compacted state. This suspended or separated elevated state yields particles with surfaces that are more accessible and available for contact with the diffused heated gases rising through the particles within the reaction chamber. Increased surface contact with diffused heated gases is believed to increase the ability of the catalytic particles to generate the reactive degrading atmosphere. Failure to partially separate the particles results in less efficient and uniform conversion of organic material into heat and electromagnetic energy.

The term “operating temperature” is meant to refer to the temperature at which hydroxyl radicals, ionized gas, heavy electrons, and/or other free radicals or reactive species capable of degrading organic materials in an enhanced exothermic reaction are generated by a catalytic media such as silica and/or alumina.

The term “portable” is meant to refer to the ability of the devices and systems used to carry out the methods of the present invention, as embodied in certain embodiments, to be capable of being moved throughout a building or medical or research facility or industrial site or energy plant or wherever needed. This movement of the device or system might be by simply carrying, wheeling by means of a supporting stand equipped with rollers or wheels, or moving by means of moving equipment (e.g., a forklift or small crane), the important feature being that a portable device or system is not primarily a fixture as the term is commonly understood.

The term “enhanced exothermic reaction” is meant to refer to a reaction wherein conditions within the reaction chamber induce or initiate a process leading to increased production of thermal energy relative to simple combustion of the organic fuel. In certain embodiments this may be the result of a catalytic media producing an electrostatic field (e.g., one or more highly localized electrostatic fields), which causes at least some electrons (e.g., through many body quantum effects) to increase in mass and form heavy electrons, which react with protons to form neutrons and neutrinos. In certain embodiments, this relatively low-energy, low-temperature production of neutrons causes a cascade of beta decay reactions within at least a portion of the organic fuel, resulting in enhanced generation of thermal energy.

In certain embodiments, an enhanced exothermic reaction results in the measurable detection of radiation emanating from the reaction chamber. In certain embodiments, an enhanced exothermic reaction leads to a decay reactions resulting in the output of alpha particles, beta particles, and/or other ionizing radiation (e.g., gamma rays, X-rays). For example, the generation of reactive species, such as ionized gas and heavy electrons, can lead to electron-proton reactions resulting in neutron formation. Neutron capture by atoms making up the organic fuel leads to beta-decay reactions, as a neutron in an unstable nucleus decays to a proton with the release of beta radiation.

### II. Thermal Reactors

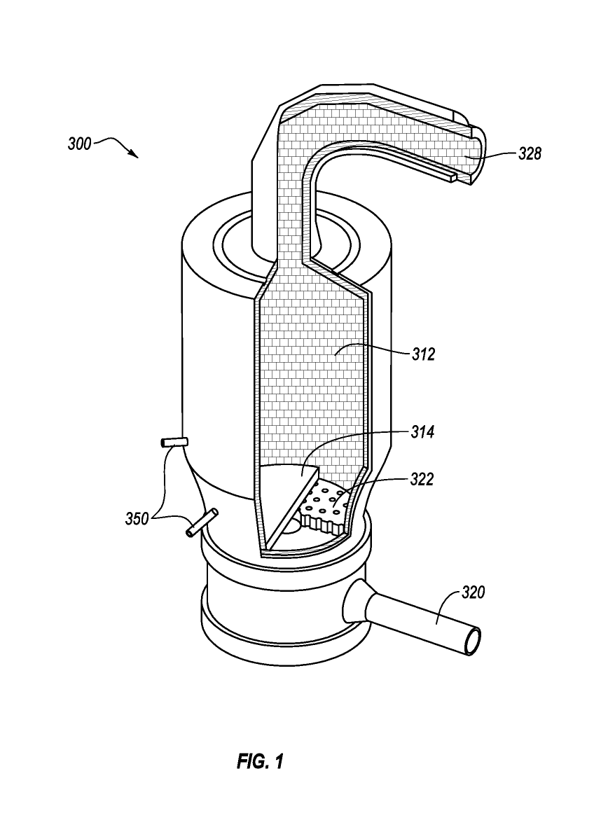

FIG. 1 illustrates an embodiment of a thermal reactor system 300 configured to receive an organic fuel and efficiently convert the fuel into thermal energy. The illustrated thermal reactor system includes a reaction chamber 312 containing a heat generation source 322 (e.g., a gas flame or electrical heating element), an air flow source 320, and exhaust conduit 328 for removal of resulting gases and/or heat. The thermal reactor system 300 also includes a catalytic media 314 (shown in a heated, reactive state in FIG. 1). Reactive species can be produced from interaction of the catalytic media 314 with the air flow through the air flow source 320 and/or the heat generation source 322. The depth of the catalytic media 314 need only be sufficient to produce a reactive environment of reactive hydroxyl radicals, ionized gas, heavy electrons, or other reactive species and can be as little as 1 inch and as high as 1 foot, with about 2-7 inches being preferred, and about 2-5 inches being most preferred. The air source 320 can be configured to direct air into the catalytic media 314 to suspend and/or churn the catalytic media.

The illustrated embodiment includes one or more fuel inputs 350 configured to receive a fuel and to channel the fuel to the heat generation source 322 within the reaction chamber 312. In some embodiments, the fuel delivered through the fuel inputs 350 is a liquid fuel, such as natural gas. The reaction chamber 312 is generally enclosed or sealed except for where air is introduced into the bottom of the reaction chamber 312 through the air flow source 320 to suspend or separate the catalytic media 314 and the exhaust conduit 328.

The catalytic media 314 can include sand-like particles of a material such as silica sand, silica gel, hydroxylbastnasite, alumina, other reactive species-generating materials known in the art or which may be developed, and the like. Silica sand, silica gel, alumina, and mixtures thereof are preferred media because of their low cost and exceptional performance in the reaction chamber 312. The catalytic particles can have an average size (e.g., diameter or cross-sectional dimension) ranging from about 0.1 mm to about 1 cm, more preferably from about 0.2 mm to about 5 mm, and most preferably from about 0.5 mm to about 2.5 mm.

The catalytic media 314 can consist essentially of silica, alumina, or mixtures thereof. The term “consist essentially of” should be understood to mean that the catalytic media 314 can be particles that mainly consist of silica, alumina or mixtures thereof, but they may include minor quantities of impurities such as metals and ash typically found in silica and/or alumina. It is believed that the silica and/or alumina, when properly activated in the presence of sufficient heat and moisture, produce a localized reactive environment of highly reactive hydroxyl radicals, ionized gas, heavy electrons, and/or other reactive species which are able to degrade organic materials and initiate an enhanced exothermic reaction.

Moreover, whereas the silica and/or alumina are believed to be responsible for the formation of a reactive environment that includes abundant reactive species such that expensive catalysts such as palladium and platinum are not necessary, inclusion of such materials in minor amounts would be within the scope of the present invention so long as the silica and/or alumina are activated and able to produce the reactive environment.

It may be advantageous to select catalytic particles that have a relatively high specific surface area. The high specific surface area can be achieved by particle size distribution as well as porosity of the particles. It is believed that it is at the surface of the catalytic particles where the reactive hydroxyl radicals or other reactive species or molecular fragments are generated. Accordingly, increasing the surface area of the catalytic particles without increasing their weight allows for the use of a lower mass of particles while maintaining a desired level of reactivity with the organic material. Reduced weight is particularly desirable in embodiments where the reaction chamber 312 can be configured to be portable. The amount of particles needed may be significantly reduced when the grain size is reduced and/or the surface of the particles is made to be more irregular, both of which tend to increase the specific surface area of the catalytic particles.

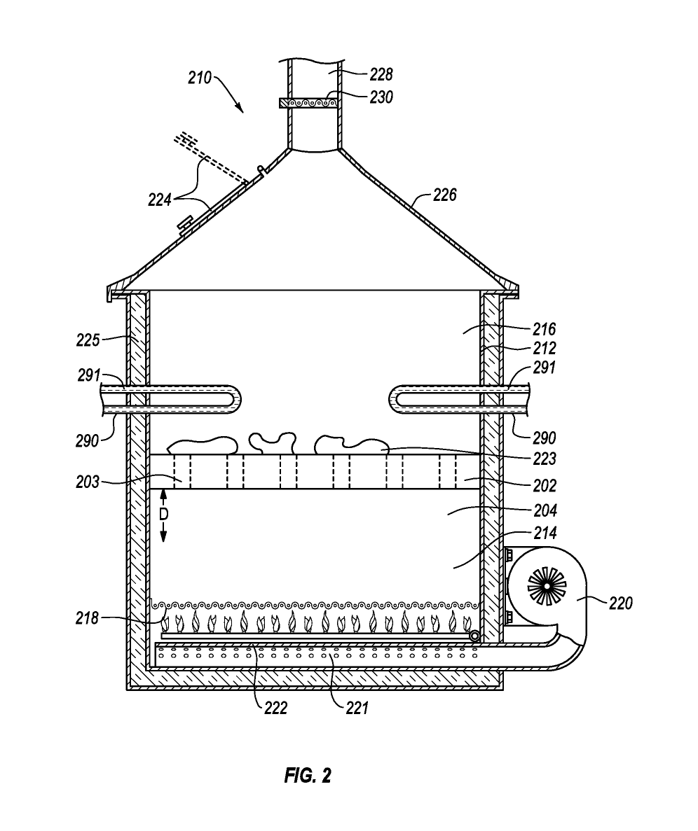

FIG. 2 illustrates another embodiment of a thermal reactor system 100. The illustrated embodiment can be configured to receive an organic fuel 123 for further fueling the reaction and producing heat and thermal radiation. For example, a thermal reactor system can be configured to operate with a fuel source such as a natural gas delivered through one or more fuel inputs (as in the embodiment of FIG. 1) and/or an organic fuel 123 positioned within the reaction chamber 112 (as in the embodiment of FIGS. 2-4).

The thermal reactor system 100 includes a reaction chamber 112 containing a heat generation source 122 (e.g., a gas flame assembly and/or electrical heating element), an air flow source 120, a base support 118, an airflow diffuser 116, a catalytic media 114, and an elevated support element 102 configured for supporting organic fuel 123 at a distance (D) above the catalytic media 114. The elevated support element 102 includes a support surface with one or more apertures 103 that permit gases to pass through and deliver reactive species produced by the catalytic media to the organic material 123. The reaction chamber 112 can include a void space 104 between the elevated support element 102 and a top filter 130 and/or an exhaust conduit 128.

The positioning of the elevated support element 102 above the catalytic media 114 at a distance D allows for the reaction chamber 112 to be capable of facilitating complete degradation and conversion of organic fuel with the production of thermal radiation. Additionally, the elevated support element 102 keeps the organic material 123 from falling into the catalytic media 114. The reaction chamber 112 can include an inlet 124 so that the organic material 123, alone or contained by the elevated support element 102, can be introduced into the reaction chamber 112.

The catalytic media 114 is shown to be positioned above an air diffuser 116 which sits upon a base support 118. Optionally, the air diffuser 116 and base support 118 can be combined into a single element that function to both 1) support the catalytic media at a desired location within the reaction chamber 112 and 2) diffuse air passed through the reaction chamber 112 so that the airflow is sufficiently diffuse to substantially uniformly suspend or separate the catalytic media 114.

In one example, the air diffuser 116 can be a bed of pebbles, rocks or particles that are substantially larger than the catalytic media 114. The airflow rates for suspending the catalytic media will generally depend on the size of the reaction chamber and/or the quantity of organic material being converted. According to one embodiment, the airflow rate can range from about 1 ft³/min to about 500 ft³/min, more preferably from about 5 ft³/min to about 250 ft³/min, and most preferably from about 10 ft³/min to about 100 ft³/min.

The air diffuser 116 can be configured to efficiently transfer heat with respect to the airflow throughout the catalytic media 114 and reaction chamber 112. When the air diffuser 116 includes rocks, they can sit atop a support plate that functions as the base support 118. On the other hand, the air diffuser 116 can be a support plate that has a sufficient amount and distribution of apertures that diffuse the air passed therethrough. The air source 120 can be oriented with respect to the air diffuser 116 and/or base support so that air introduced through the air diffuser 116 can travel upward through the catalytic media 114 and not downward and away from the catalytic media 114. The base support 118 (e.g., support plate) can include a heat conductive material (e.g., metal) for effective heat transfer when heat is used to regulate the temperature of the reaction chamber 112.

An air source 120 blows forced air through the catalytic media 114 to a partially suspend and/or churn the catalytic media 114. An example of an air source 120 can include air jets from an air compressor. The air jets can be located below or within the air diffuser 116 to facilitate a more disperse airflow through the catalytic media 114. However, the air jets can be situated directly within the catalytic media 114, typically in embodiments where an air diffuser 116 is not employed. Also, the air jets can be located below a base support 118 that has apertures that can diffuse the airflow.

The air introduced into the reaction chamber 112 by the air source 120 can be heated to a desirable temperature. For example, the airflow from air jets may be preheated to approximately the desired temperature of the reaction chamber 112, or it may become heated by means of heat that radiates through the base support 118 and/or air diffuser 116. Also, a heat generation source 122 can be provided in an orientation that provides a flame or electrical heating element as a means for heating the base support 118 and/or air diffuser 116. The heat generation source 122 may include one or more burners that burn a carbon fuel source (e.g., natural gas). Alternatively, the heat generation source 122 can be an electric resistive heater or any other device that can transfer heat to the base support 118, air diffuser 116, catalytic media 114, or airflow from the air source 120.

In embodiments where heated air is introduced into the reaction chamber 112 (e.g., by air jets), the air may be preheated by a number of means, including electric heating means or radiant heating means heated by a fuel such as natural gas, fuel oil, or coal, where it is desired to pass pure air through the reaction chamber 112. However, it may be more economical to simply introduce and burn natural gas within the reaction chamber 112 (e.g., within or near the catalytic media 114). Because natural gas produces mainly water and carbon dioxide, it should not inhibit the reaction process within the reaction chamber 112. Generation of water vapor from natural gas may enhance the reactivity of the catalytic media 114 through production of hydroxyl radicals and protons (e.g., through water splitting reactions). Other combustion gases besides natural gas can be used. Because the combustion gases are preferably blended with introduced airflow in order to provide the proper temperature conditions, the air that is introduced into the reaction chamber 112 can include adequate oxygen in most cases. However, it is possible to enrich the air with pure oxygen if desired to increase the reactivity within the reaction chamber 112.

The airflow through the catalytic media 114 should have sufficient velocity and pressure to cause the catalytic media 114 to become partially suspended. In order to obtain the best and most efficient conversion of organic materials, it may be preferable to blow just enough air to cause adequate suspension of the media so that the elevated support element 102 holding an organic material 123 remains a distance (D) (e.g., at least 2 inches, preferably at least about 3 inches, more preferably at least about 5 inches, and most preferably at least about 8 inches) over the catalytic media 114 when suspended. Alternatively, the elevated support element 102 can be adjusted to a distance (D) from the top of the catalytic media 114 within the void space 104 in order to effect optimal conversion of the organic material 123. However, it should be considered that the less air that actually passes through the reaction chamber 112, while maintaining adequate suspension, will use less energy and produce a lower quantity of resulting gases that are vented from the reaction chamber 112.

The reactor system 100 can be equipped with means for introducing organic materials 123 into the reaction chamber 112, where the organic materials 123 can be packaged or loose on the elevated support element 102. The organic materials 123 can be placed on the elevated support element 102 prior to introduction of the elevated support element into the reaction chamber 112, or they can be placed onto the elevated support element 102 already installed or positioned in the reaction chamber 112. One or more entrances 124 can be included, such as doors, ports, continuous inlets, or any other configuration that allows the organic materials 123 to be positioned on the elevated support element 102 in the reaction chamber 112 during conversion. The entrance 124 can be configured to be capable of quickly opening to receive the organic material 123, and then closing in order to retain the heat within the reaction chamber 112. In an alternative embodiment, the entrance 124 may include a set of double doors to better retain heat within the reaction chamber 112, with a first door opening to allow the introduction of the organic material within a pre-chamber (not shown), after which a second door opens up into the main reaction chamber 112.

In some instances, such as where very large pieces of organic material are introduced into the reaction chamber 112, it might be preferable to open the reaction chamber 112 by removing a lid 126 covering the top of the reaction chamber 112. The lid 126 can be removed from the main body 125 of the reaction chamber 112.

The reactor 100 can include an exhaust conduit 128 positioned above the reaction chamber 112 so that produced gases can be released. Optionally, the exhaust conduit 128 can be located near the entrance 124 and/or the lid 126 at the top of the reaction chamber 112, which carries the gases to an appropriate location for emission into the outside air. Heat within the waste gases can also be recycled back into the reaction chamber 112 by any appropriate method known to those of ordinary skill in the art, such as by heat exchange, to heat up the air introduced into the reaction chamber 112, or by simply recirculating the gases back into the reaction chamber 112 to ensure complete and efficient breakdown of essentially all organic materials and gases. This may be one means of ensuring the complete conversion and/or destruction of any biological materials, such as viruses or pathogenic agents.

In one embodiment, a method for efficiently converting organic materials into thermal energy can be performed by a thermal reactor as described herein. The conversion method can be performed in a manner for enhancing energy production from carbon fuels, as well as for destroying biological waste, municipal waste, medical waste, and/or animal or human corpses, for example. In some embodiments, operation of the reactor includes an enhanced exothermic reaction to efficiently produce high levels of thermal energy, as explained in further detail below.

According to one embodiment, the temperature within reaction chamber 112 can be maintained in a range from about 350° C. to about 600° C., or at about 550° C. This temperature can be obtained at in the void space 104, such as at the elevated support element 102 at a distance (D) above the catalytic media 114. This temperature can be initially achieved by the heat generation source 122 and/or air source 120. In embodiments using an organic material 123 as fuel, the heat generation source 122 can be extinguished and/or reduced in heat production once the organic material 123 begins to convert and produce heat energy, and/or the air source 120 flow rate can be adjusted so that the conversion of the organic material 123 to heat energy is maintained. The conversion of the organic material 123 can be maintained even when the heat generation source 122 is deactivated. Alternatively, the heat generation source 122 can continue to provide fuel to the reaction chamber 112. For example, in some embodiments organic materials 123 are omitted and the heat generation source 122 continues to supply a fuel (e.g., natural gas) to the reaction chamber 112 to maintain heat generation.

In other embodiments, the temperature within the reaction chamber 112 is raised to a temperature above about 600° C. For example, the thermal reactor may be operated so as to bring the temperature within the reaction chamber 112 to a temperature of about 600° C. to about 1800° C. In some embodiments, the reaction chamber 112 is brought to a temperature of about 600° C., 800° C., 1000° C., 1200° C., 1400° C., 1600° C., 1800° C., or ranges therebetween.

Because of the oxidative nature of the process for converting fuels and/or organic materials into heat energy, it may be preferable to ensure that there is abundant oxygen within the air being introduced into the reaction chamber 112. In some embodiments it might be desirable to adjust the composition of the atmosphere within the reaction chamber 112. For example, it may be desirable to increase the amount of oxygen within the reaction chamber 112 by intermittently injecting oxygen in order to facilitate oxidation of a particular biological material. Most organic wastes naturally contain water, which can yield additional hydroxyl radicals hydroxyls, and protons during the process. Supplemental gas may be introduced together with the air by means of the air source 120 or other gaseous inlet.

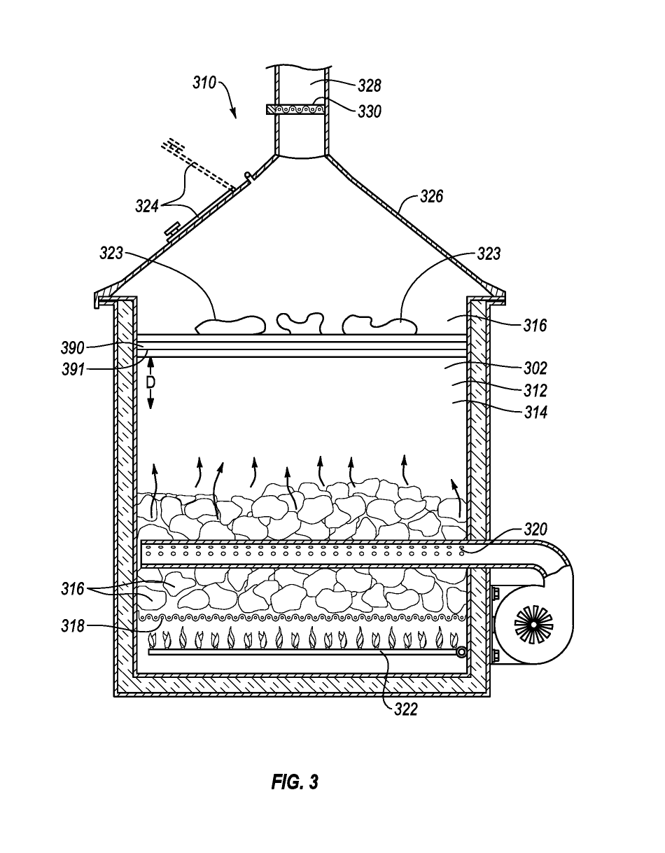

FIG. 3 illustrates another embodiment of a reactor 210 that can be used for generating thermal radiation by consuming a fuel (e.g., natural gas) delivered through a heat generation source 222 and/or by using organic substances 223. The reactor 210 can include a reaction chamber 212 containing a heat generation source 222, an air source 220 with an air inlet 221, a base support 218 configured to diffuse airflow, a catalytic media 214, and an support element 202 configured to hold an organic material 223 at a distance (D) above the catalytic media 214 when suspended. The support element 202 includes one or more apertures 203 so that gases can pass therethrough and deliver reactive species to convert the organic material 223.

Suspension of catalytic media 214 within the reaction chamber 212 maintains a void space 204 between the catalytic media 214 particles and the support element 202. The support element 202 is configured to retain the organic material 223 above the catalytic media 214 through the various stages of conversion or degradation and keeps the catalytic media 214 from being filled with ash or other foreign materials.

The reaction chamber 212 can include an inlet 224 so that the organic material 223, alone or contained by the support element 202, can be introduced into the reaction chamber 212. The reaction chamber 212 can be configured with a lid 226 that can be entirely removed for loading large organic materials 223 as well as the support element 202 into the reaction chamber 212. In addition, the support element 202 may be removed or omitted, and the thermal reactor may be operated without any organic materials 223. For example, the reactor 210 may be brought to a sufficient operating temperature using only the heat generation source 222.

The illustrated reaction chamber 212 includes an exhaust conduit 228 so that gases produced by conversion of the organic materials 223 can be removed. The exhaust conduit 228 can include a filter or baghouse 230 so that particulates, such as ash, do not pass through the exhaust conduit 228 and into the atmosphere. The reaction zone 216 can be located at or above the support element 202 up to the filter 230, where the organic materials and any incomplete combustion products can be converted or further converted and degraded.

The embodiment of the reactor bed of FIG. 3 can be beneficial because the air can be blown into the reaction chamber 212 below the heat generation source 222 so that the air blown into the reaction chamber 212 by the air source 220 through the air inlet 221 blows past the heat generation source 222 so as to heat the airflow. The flame source 222 can also heat the base support 218, which can in turn heat the airflow.

The energy generator may include a heat exchanger 290 that can be partially located within the reaction chamber 212. More particularly, the heat exchanger 290 can be located within the reaction zone 216 so that heat from conversion of organic material and/or fuel delivered through heat generation source 222 can heat a heat exchanger fluid 291. The heated heat exchanger fluid 291 can then be used to convert heat energy to electrical energy as is well known, such as through steam generators. The number, orientation, location, or other parameter of the heat exchanger 290 can be modulated so that any number can be used and so that the location of the heat exchanger 290 is optimum for heat exchange.

While the reactors described herein can be scaled up or down depending on industrial or bench-top settings, the reaction chamber can be exemplified by a cross-sectional dimension of from about 1 foot to 10 feet, or from about 1.5 feet to about 8 feet, or from about 2 feet to about 6 feet, or from about 2.5 feet to about 5 feet, or from about 3 feet to about 4 feet. The corresponding void space or reaction chamber height for one of these cross-sectional dimensions can range from about 3 feet to about 15 feet, or from about 3.25 feet to about 10 feet, or from about 3.5 feet to about 8 feet, or from about 4 feet to about 6 feet, or about 5 feet.

In a one embodiment, the catalytic media particles are suspended in a fairly static condition against the force of gravity by means of air flowing upwards through the particles. Such airflow can be provided by any gas pressurizing means known in the art, including turbines, fans, pumps, or the like. Suspending the catalytic particles greatly increases the active surface area of the silica and/or alumina particles by separating them slightly and allowing for more gas-to-particle contact for producing the reactive species.

According to one embodiment, natural gas is combusted within a thermal reactor to reach an initial temperature of 540° C. within 20 seconds from a cold start. Air is injected into the reactor to start reactions involving the organic material and the catalytic media particles in the reaction chamber of the thermal reactor. In some embodiments, natural gas flow is cut off when a temperature of about 540-1000° C. is reached and heat production continues through the degradation of an organic fuel added to the thermal reactor and/or through the action of an enhanced exothermic reaction. The degradation of the organic fuel can produce increased temperature without producing a flame.

Because the catalytic media is a source for reactive species that are generated from the interaction of the catalytic particles, oxygen, and the fuel (e.g., organic materials, natural gas, etc.), the catalytic media might be expected to break down over time, or become depleted as organic materials are converted into thermal energy. In fact, it appears that a measurable fraction of the catalytic media is broken down over time, although the amount is extremely small in comparison to the molar equivalents of fuel being converted or consumed. An advantage of the present invention is the exploitation of the highly reactive nature of the reactive species produced from the catalytic media instead of the enormous amounts of energy that are expended in producing a sufficiently hot incinerator to combust organic materials and/or destroy the wastes by burning. This advantage is particularly apparent in light of the extremely low cost of catalytic media such as silica or alumina, which are readily available, largely inert until exposed to the reactive conditions, and very inexpensive. Further, this advantage is apparent in light of enhanced exothermic reactions initiated through the activity of the catalytic media.

Because of the nature of the conversion process, it is possible to greatly upscale or downscale the reactor size to accommodate a variety of uses. The reaction apparatus and chamber may be very large in order to serve large institutional needs such as a huge medical or research complex as well as industrial energy production. Conversely, it may be very small and portable when an amount of thermal radiation required is small, when used to destroy a small but steady stream of medical wastes, and/or when used for local or personal energy production. The latter also provides for ease in moving and placement of the reactor in the most convenient location.

### III. Enhanced Exothermic Operation

In certain embodiments and/or under certain modes of operation, a thermal reactor as described herein can initiate or promote an enhanced exothermic reaction. For example, an enhanced exothermic reaction can result where interactions between the catalytic media and the air, organic fuel, and/or generated heat produce an electrostatic field within the reaction chamber. In addition, the air within the reaction chamber can become at least partially ionized (e.g., resulting in a dust plasma within the reaction chamber). The electrostatic field can affect the electrons (e.g., the ionized electrons of the plasma or other electrons associated with the reactive species of the reactor), or at least a portion of the electrons such that they gain an amount of mass and become heavy electrons. The production of heavy electrons initiates the interaction of the heavy electrons with protons, such as protons within the organic fuel, within the reactive species, and/or free protons resulting from the splitting of water or from degradation of the organic fuel.

The interaction of heavy electrons and protons results in the formation of neutrons. Neutrons are rapidly captured by atoms within the reaction chamber, such as the atoms of the organic fuel. After neutron capture, an atom will exist in a state of higher atomic mass. If the isotope is unstable, the nucleus of the atom will undergo beta decay, in which a neutron within the nucleus is converted to a proton, with the resulting emission of an energetic beta particle (electron).

Even in circumstances where the enhanced exothermic reaction is small or sporadic, it should be noted that any such enhancement will increase the energy output from the reaction and will better sustain the exothermic reaction taking place within the reaction chamber (thereby reducing or eliminating the risk of incomplete combustion and reducing the amount of input heat/energy required to maintain the reaction). The conversion of the organic material provides heat to the reaction chamber within the reaction zone such that the temperature can be maintained or even increased once gas supply to a flame source is reduced or stopped, such as when conditions in the reaction chamber induce an enhanced exothermic reaction.

An exemplary beta decay cascade based on a carbon fuel source proceeds when a ¹²C carbon atom captures a neutron produced as a result of operation of the reactor to produce a ¹³C carbon atom. Upon capture of another neutron to form a ¹⁴C atom, the relatively unstable ¹⁴C atom can undergo beta decay by which a neutron forms a proton along with the emission of beta radiation. The resulting ¹⁴N atom can capture further neutrons to become, successively, a ¹⁵N and then a ¹⁶N atom. The relatively unstable ¹⁶N atom can undergo beta decay, resulting in a ¹⁶O atom and the generation of further beta radiation.

The emitted radiation resulting from the enhanced exothermic reaction enhances the thermal energy output of the reactor to levels beyond levels obtained during simple combustion of the input fuel only. For example, the energy released as a result of the beta decay reactions, or a portion thereof, can be transformed into infrared radiation that further increases the temperature of the reaction chamber. In one example, the electrostatic field generated through the action of the catalytic media causes a wavelength shift in at least a portion of the generated radiation (e.g., gamma radiation), thereby increasing the temperature and thermal energy output of the reactor.

### IV. Examples

### Example 1

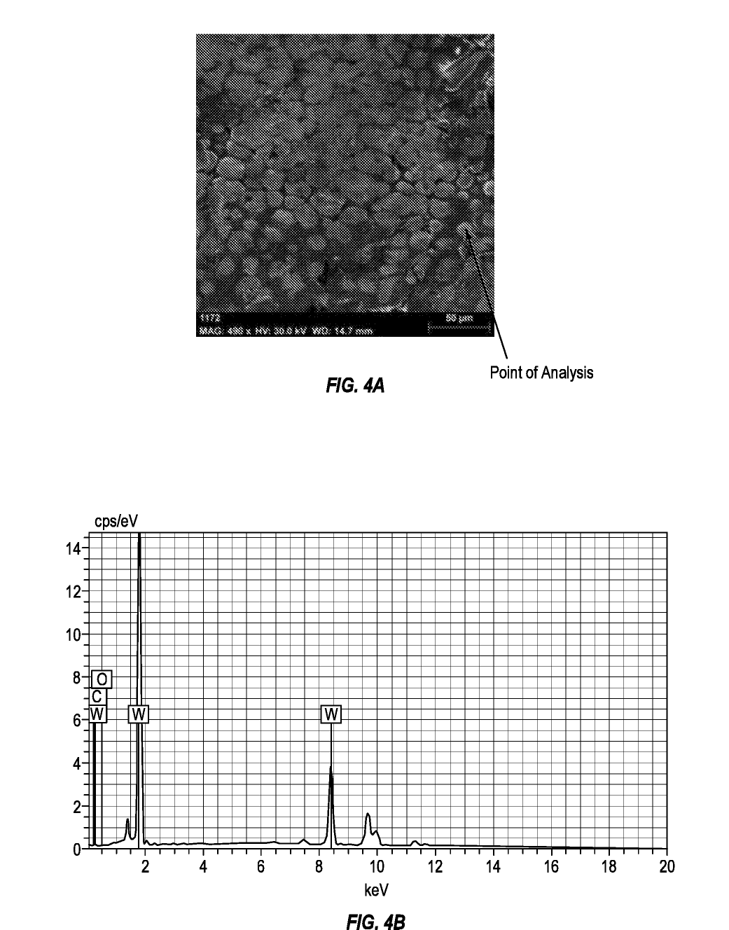

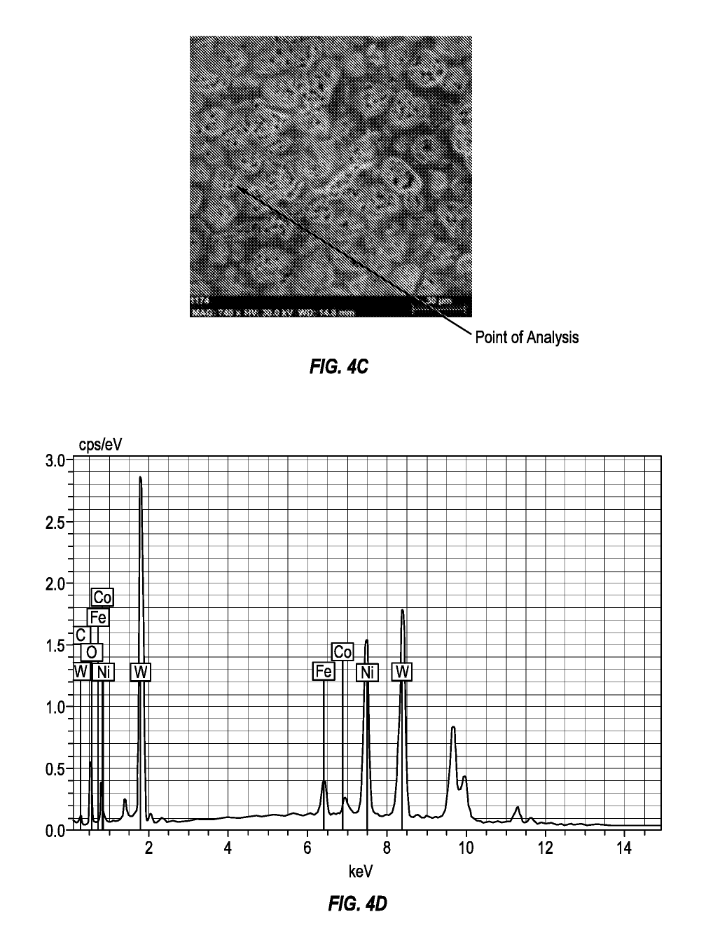

Tungsten samples were treated in a reactor substantially as described herein for several hours (about 2-3 hours). FIG. 4A shows a microscopic view of the surface of a tungsten sample before treatment, and FIG. 4B illustrates spectral analysis results of the tungsten sample before treatment in the reactor (point of analysis shown in FIG. 4A). Analysis was performed through scanning electron microscopy with energy dispersive X-ray spectroscopy (SEM/EDS). FIG. 4C shows a microscopic view of the surface of the tungsten sample after treatment, and FIG. 4D illustrates SEM/EDS analysis results of the tungsten sample after treatment. Tabulated composition data from the SEM/EDS analysis of FIG. 4B is shown in Table 1, and from the SEM/EDS analysis of FIG. 4D is shown in Table 2.

TABLE 1
Tungsten before Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Tungsten | 94.14 | 89.91 | 38.34 | 7.00 |
| Carbon | 7.85 | 7.50 | 48.94 | 4.76 |
| Oxygen | 2.72 | 2.60 | 12.72 | 2.00 |
| Total | 104.71 | 100.00 | 100.00 | |

TABLE 2
Tungsten after Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Tungsten | 70.83 | 63.89 | 17.14 | 5.33 |
| Oxygen | 17.25 | 15.56 | 47.97 | 8.25 |
| Nickel | 15.27 | 13.77 | 11.57 | 1.24 |
| Carbon | 5.97 | 5.36 | 22.09 | 4.22 |
| Iron | 1.55 | 1.40 | 1.24 | 0.22 |
| Total | 110.86 | 100.00 | 100.00 | |

As shown by the results, the tungsten sample had a normalized composition after treatment with less carbon and more oxygen, which is expected following an enhanced exothermic reaction with generation of beta particles as described herein. The sample additionally showed amounts of iron, which was not present in the sample before treatment, also suggesting the presence of a beta decay reactions within the reactor.

### Example 2

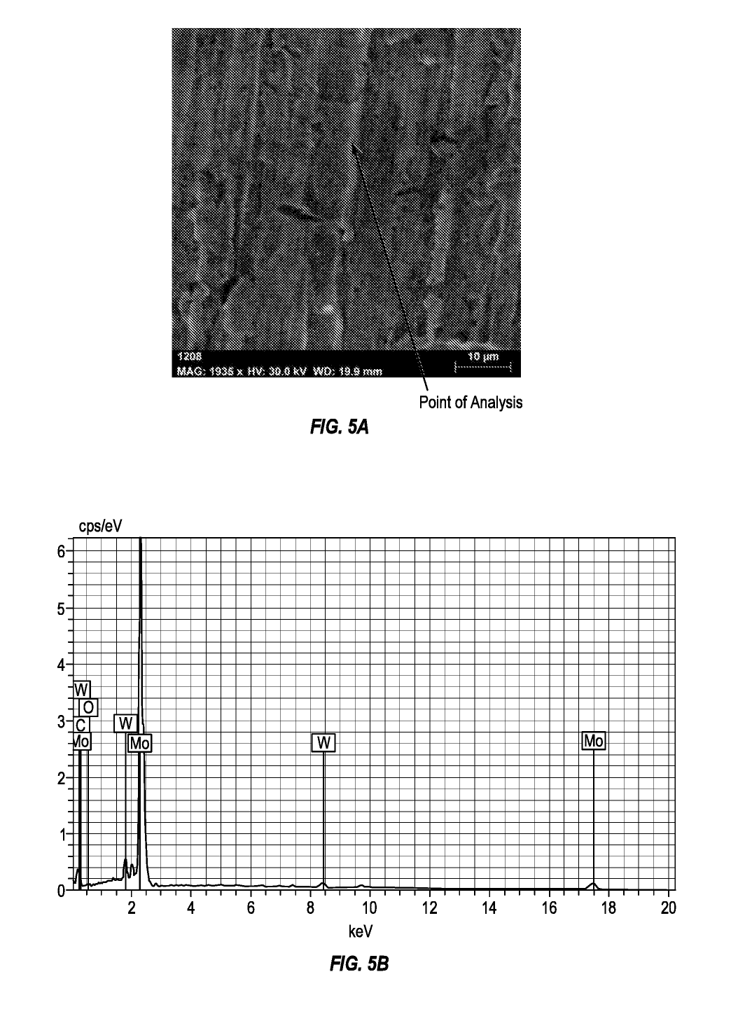

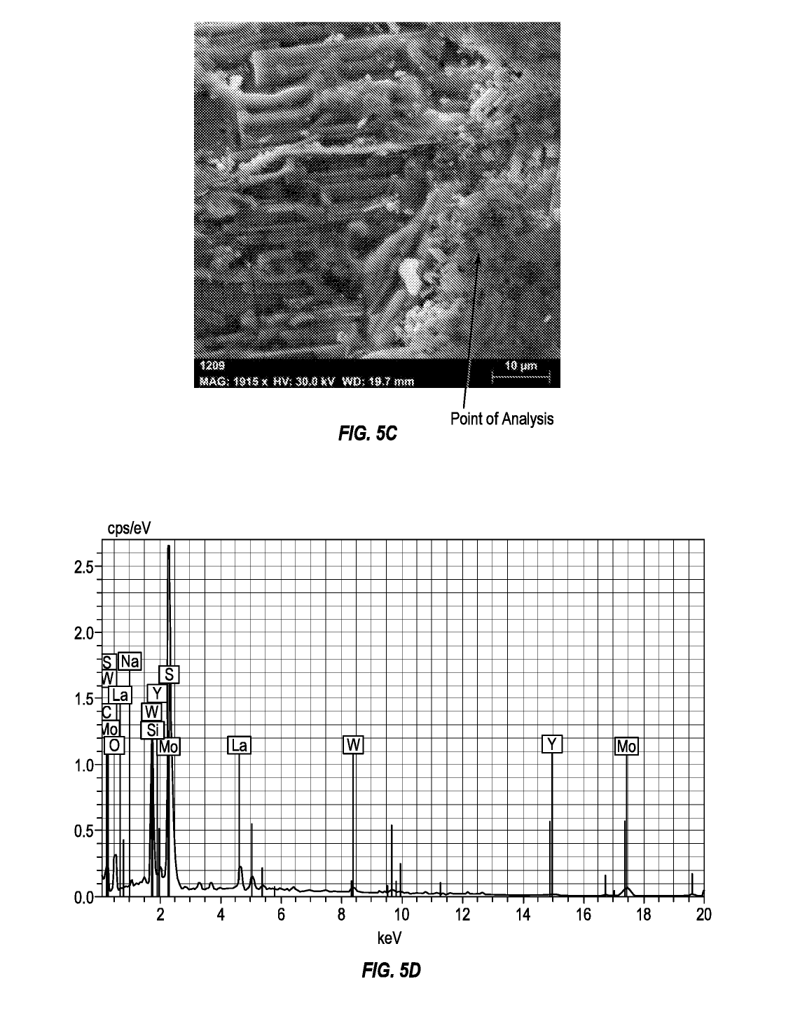

Molybdenum samples were treated in a reactor substantially as described herein for several hours (about 2-3 hours). FIG. 5A shows a microscopic view of the surface of a molybdenum sample before treatment, and FIG. 5B illustrates SEM/EDS analysis results of the sample before treatment (point of analysis shown in FIG. 5A). FIG. 5C shows a microscopic view of the surface of the sample following treatment, and FIG. 5D illustrates SEM/EDS analysis results of the sample following treatment (point of analysis shown in FIG. 5C). Tabulated composition data from the SEM/EDS analysis of FIG. 5B (before treatment) is shown in Table 3, and from FIG. 5D (after treatment) is shown in Table 4.

TABLE 3
Molybdenum before Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Molybdenum | 109.97 | 73.66 | 28.90 | 11.14 |
| Carbon | 27.78 | 18.61 | 58.32 | 15.81 |
| Oxygen | 7.78 | 5.21 | 12.26 | 6.09 |
| Tungsten | 3.76 | 2.52 | 0.52 | 0.45 |
| Total | 149.30 | 100.00 | 100.00 | |

TABLE 4
Molybdenum after Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Oxygen | 63.16 | 37.95 | 60.66 | 28.49 |
| Molybdenum | 72.01 | 43.27 | 11.53 | 8.33 |
| Carbon | 18.64 | 11.20 | 23.85 | 11.91 |
| Silicon | 4.01 | 2.41 | 2.19 | 0.64 |
| Lanthanum | 3.07 | 1.85 | 0.34 | 0.38 |
| Tungsten | 1.76 | 1.06 | 0.15 | 0.29 |
| Yttrium | 2.18 | 1.31 | 0.38 | 0.52 |
| Sulfur | 0.87 | 0.52 | 0.42 | 0.20 |
| Sodium | 0.72 | 0.43 | 0.48 | 0.29 |
| Total | 166.42 | 100.00 | 100.00 | |

As shown by the results, the molybdenum sample had a normalized composition after treatment with less carbon and more oxygen, which is expected following an enhanced exothermic with generation of beta particles as described herein. The sample additionally showed amounts of silicon, lanthanum, yttrium, sulfur, and sodium, which were not present in the sample before treatment, also suggesting the presence of a beta decay reactions within the reactor.

### Example 3

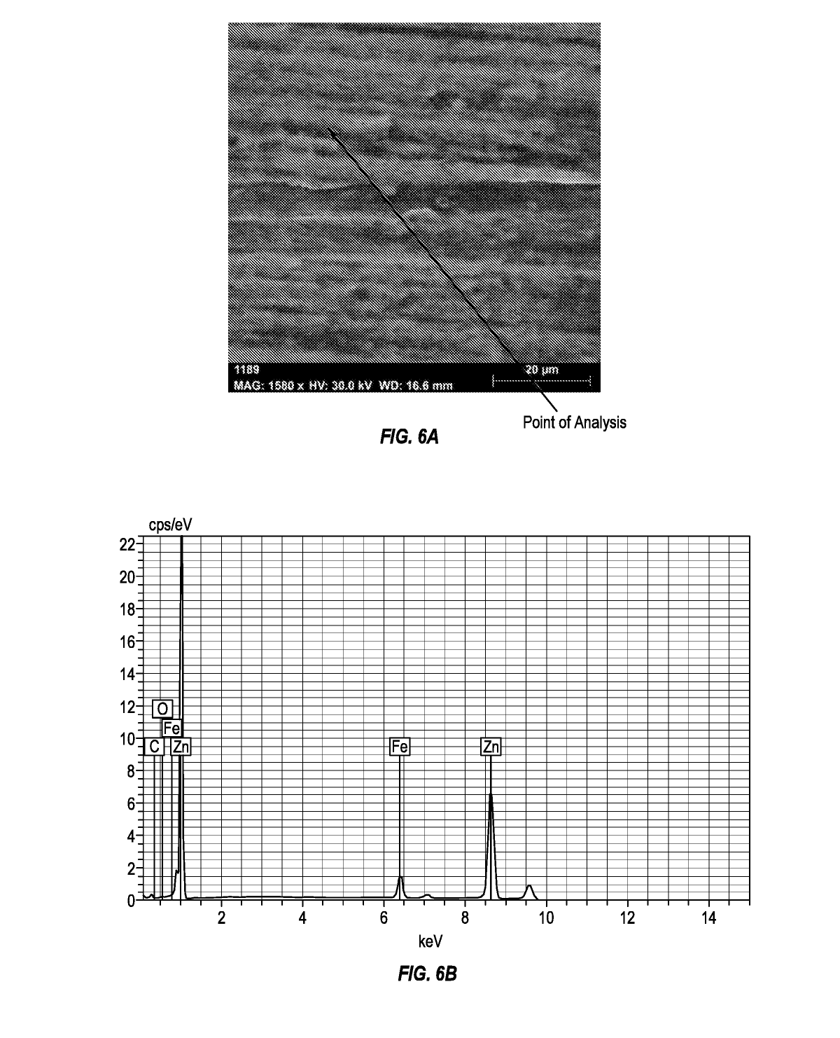

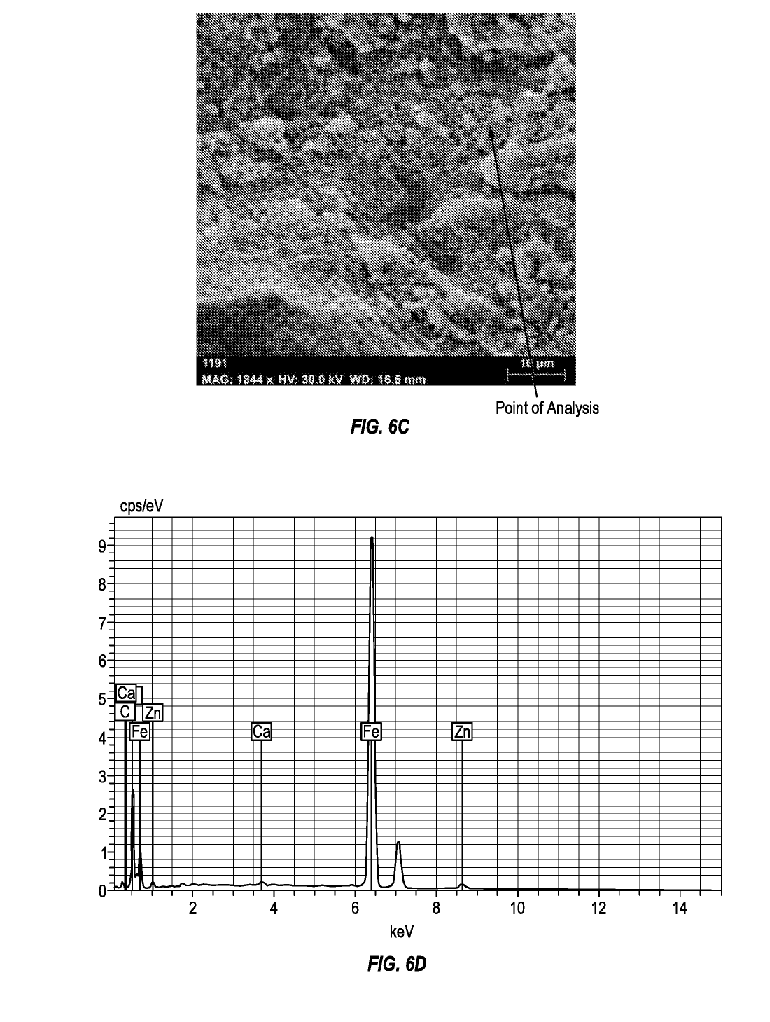

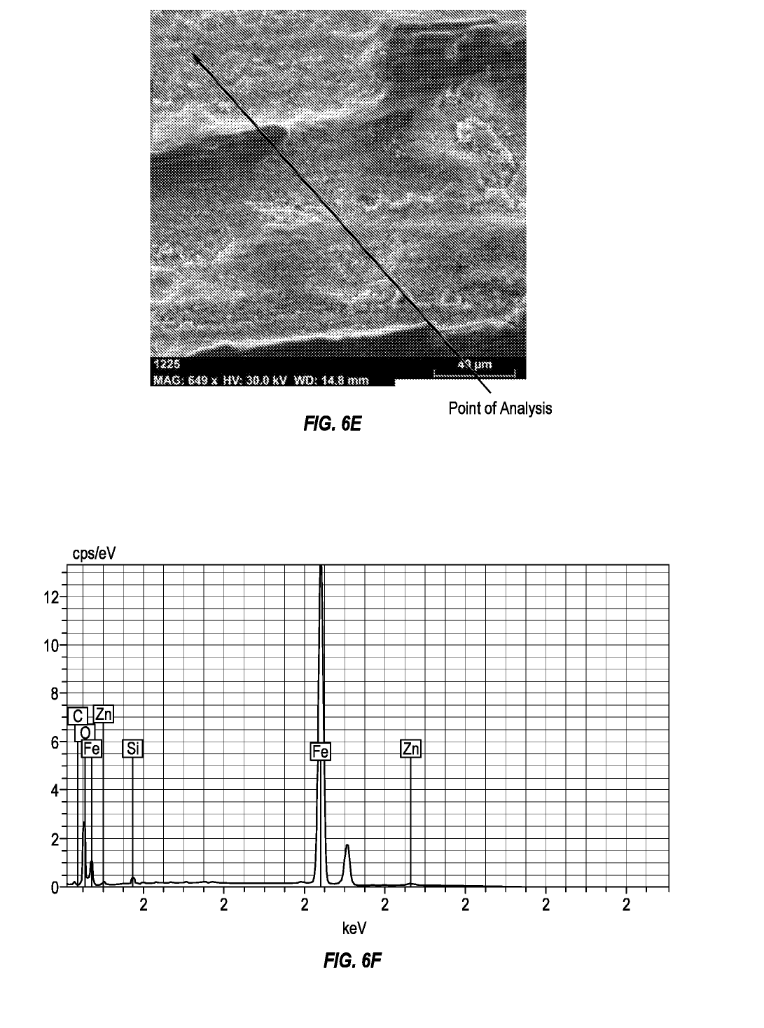

Galvanized wire samples were treated in a reactor substantially as described herein for several hours (about 2-3 hours). FIG. 6A shows a microscopic view of the surface of the galvanized wire before treatment, and FIG. 6B illustrates SEM/EDS analysis results of the sample before treatment (point of analysis shown in FIG. 6A). FIG. 6C shows a microscopic view of the surface of the sample following treatment, and FIG. 6D illustrates SEM/EDS analysis results of the sample following treatment (point of analysis shown in FIG. 6C). FIG. 6E shows another microscopic view of another section of the sample following treatment, and FIG. 6F illustrates the corresponding SEM/EDS analysis results. Tabulated composition data from the SEM/EDS analysis of FIG. 6B (before treatment), FIG. 6D (after treatment), and FIG. 6F (after treatment), are shown in Tables 5-7, respectively.

TABLE 5
Galvanized Wire before Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Zinc | 77.73 | 78.84 | 48.84 | 5.80 |
| Carbon | 11.84 | 12.01 | 40.50 | 6.97 |
| Iron | 6.83 | 6.93 | 5.02 | 0.61 |
| Oxygen | 2.20 | 2.23 | 5.64 | 1.62 |
| Total | 98.60 | 100.00 | 100.00 | |

TABLE 6
Galvanized Wire after Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Iron | 69.76 | 66.14 | 35.77 | 5.38 |
| Carbon | 4.98 | 4.72 | 11.88 | 3.72 |
| Oxygen | 28.70 | 27.22 | 51.38 | 11.49 |
| Zinc | 1.73 | 1.64 | 0.76 | 0.26 |
| Calcium | 0.29 | 0.28 | 0.21 | 0.12 |
| Total | 105.47 | 100.00 | 100.00 | |

TABLE 7
Galvanized Wire after Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Iron | 78.43 | 72.64 | 42.67 | 6.03 |
| Oxygen | 22.92 | 21.22 | 43.52 | 9.19 |
| Carbon | 4.97 | 4.60 | 12.57 | 3.49 |
| Silicon | 0.76 | 0.70 | 0.82 | 0.20 |
| Zinc | 0.89 | 0.83 | 0.42 | 0.18 |
| Total | 107.97 | 100.00 | 100.00 | |

As shown by the results, the galvanized wire sample had a normalized composition after treatment with an altered elemental composition, suggesting the presence of beta decay reactions within the reactor.

### Example 4

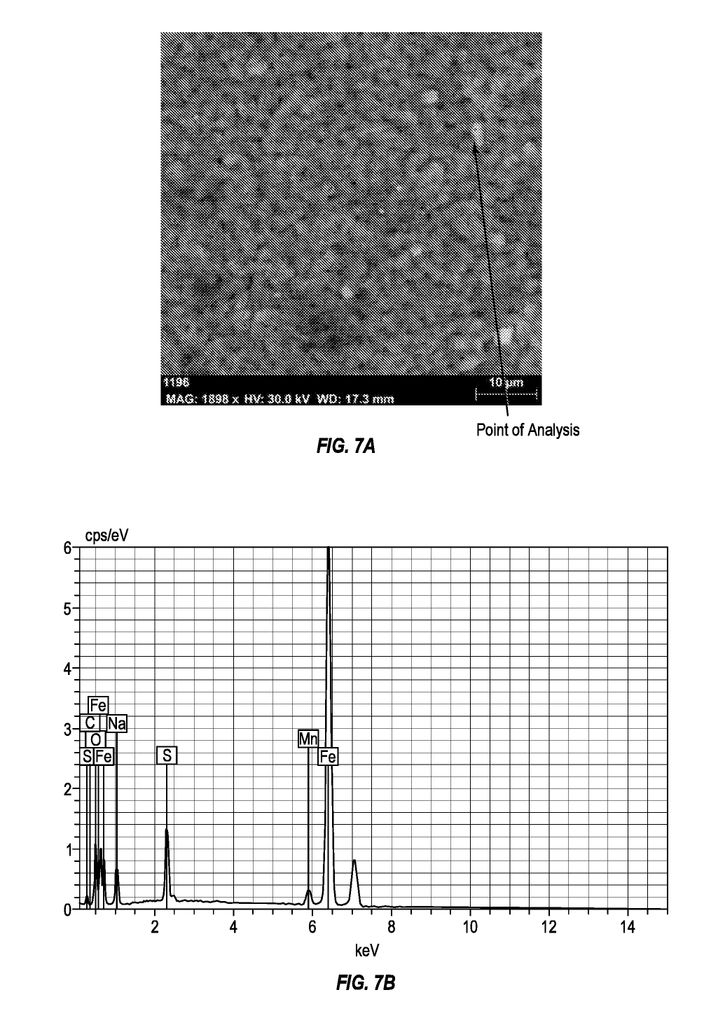

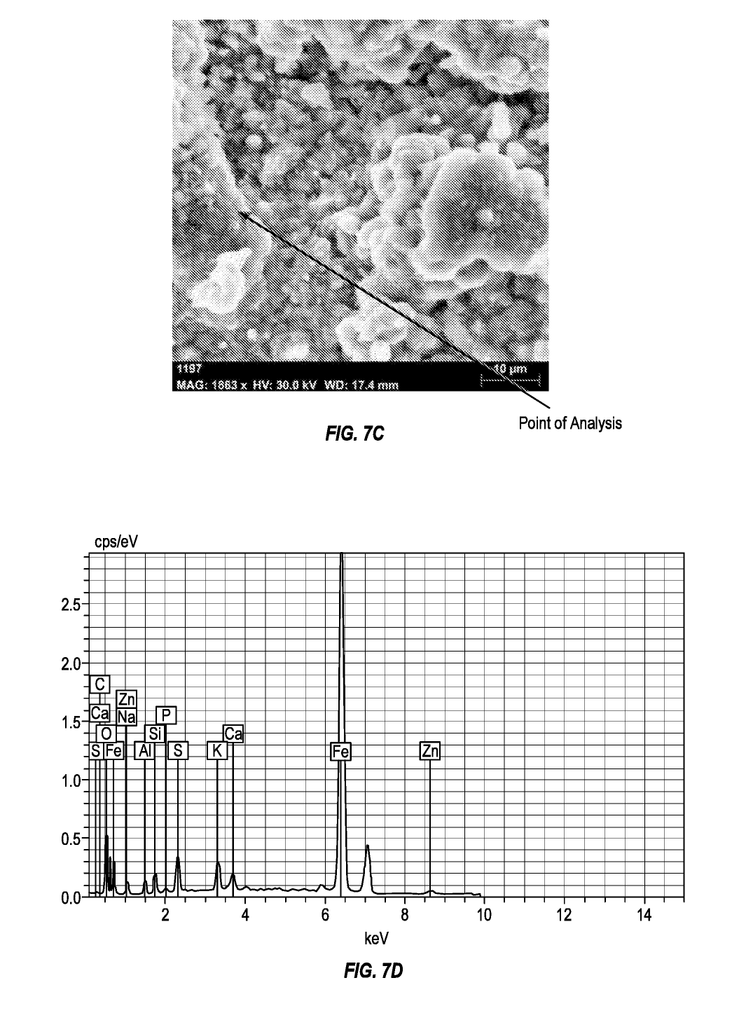

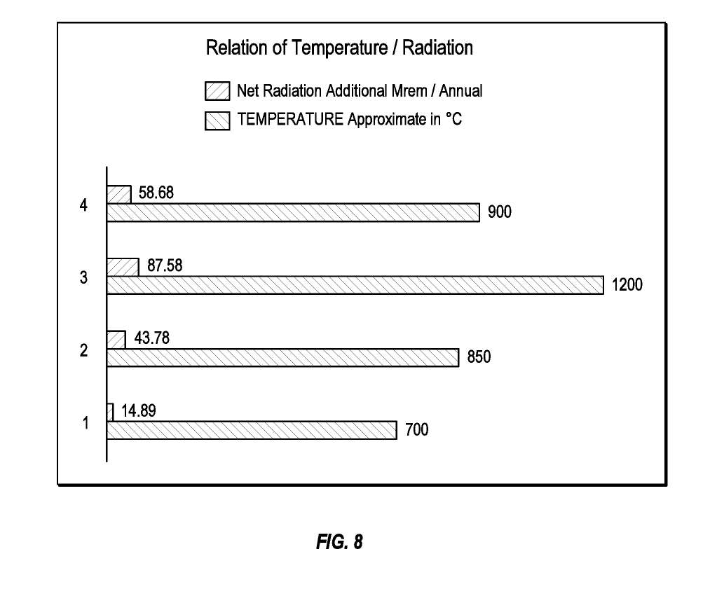

An iron plate was treated in a reactor substantially as described herein for several hours (about 2-3 hours). FIG. 7A shows a microscopic view of the surface of the iron plate before treatment, and FIG. 7B illustrates SEM/EDS analysis results of the sample before treatment (point of analysis shown in FIG. 7A). FIG. 7C shows a microscopic view of the surface of the sample following treatment, and FIG. 7D illustrates SEM/EDS analysis results of the sample following treatment (point of analysis shown in FIG. 7C). Tabulated composition data from the SEM/EDS analysis of FIG. 7B (before treatment) is shown in Table 8, and from FIG. 7D (after treatment) is shown in Table 9.

TABLE 8
Iron Plate before Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Iron | 46.81 | 39.54 | 16.76 | 3.65 |
| Oxygen | 44.51 | 37.60 | 55.61 | 16.96 |
| Sodium | 13.72 | 11.59 | 11.93 | 2.99 |
| Carbon | 7.50 | 6.34 | 12.48 | 5.09 |
| Sulfur | 4.23 | 3.57 | 2.63 | 0.56 |
| Manganese | 1.61 | 1.36 | 0.59 | 0.23 |
| Total | 118.38 | 100.00 | 100.00 | |

TABLE 9
Iron Plate after Treatment

| | Unnormalized | Normalized | Atomic | Error (3 |
|---|---|---|---|---|
| | Composition | Composition | Composition | Sigma) |
| Element | (wt. %) | (wt. %) | (Atomic %) | (wt. %) |
| Iron | 43.58 | 63.76 | 37.14 | 3.44 |
| Oxygen | 14.72 | 21.55 | 43.80 | 7.50 |
| Sodium | 2.73 | 3.99 | 5.64 | 0.82 |
| Sulfur | 1.54 | 2.26 | 2.29 | 0.29 |
| Aluminum | 0.79 | 1.16 | 1.40 | 0.26 |
| Silicon | 0.94 | 1.37 | 1.59 | 0.25 |
| Potassium | 1.32 | 1.93 | 1.60 | 0.23 |
| Calcium | 0.77 | 1.13 | 0.91 | 0.18 |
| Carbon | 1.30 | 1.90 | 5.14 | 2.07 |
| Zinc | 0.65 | 0.96 | 0.48 | 0.19 |
| Total | 68.34 | 100.00 | 100.00 | |

As shown by the results, the steel plate had a normalized composition after treatment with an altered elemental composition, suggesting the presence of beta decay reactions within the reactor.

### Example 5

To determine whether the increase and maintenance of elevated temperatures was due to an enhanced exothermic reaction occurring within the reaction chamber, coal was again tested in the device. Once the chamber was brought to a temperature of 540 C, the gas was shut off and the coal was inserted into the reaction chamber. Radiation emanating from the device was then measured using a standard radiation meter. At locations in the vicinity of the operating reactor (within about 5 to 10 feet), radiation was measured at levels of 0.113 μSv per hour, 3.189 μSv per hour, and as high as 26.62 μSv per hour.

### Example 6

Coal samples from both before and after being processed in the reactor were analyzed for a variety of elements using inductively coupled plasma mass spectrometry (ICP-MS). Each sample was prepared with a 0.1 g weighed portion mixed with 1 ml nitric acid and 3 ml hydrochloric acid, then heated at a heating block setting of 110 C for 1 hour. After cooling, 0.5 ml of 30% hydrogen peroxide was added and heating was continued for 30 minutes. After cooling, a third party internal standard solution was added and dilution with purified water to 100 g produced the solution for ICP-MS analysis. Table 10 illustrates the results of the sample of coal before reaction, and Table 11 illustrates the results of the samples (duplicate) after processing in the reactor.

TABLE 10
BEFORE REACTION

| Element | Ppm |
|---|---|
| Aluminum | 250 |
| Antimony | 0 |
| Arsenic | 0 |
| Barium | 0.64 |
| Beryllium | 0.12 |
| Bismuth | 0 |
| Boron | 0 |
| Bromine | 0 |
| Cadmium | 0 |
| Calcium | 0 |
| Cerium | 0.14 |
| Cesium | 0 |
| Chromium | 0 |
| Cobalt | 0.33 |
| Copper | 1.1 |
| Dysprosium | 0 |
| Erbium | 0 |
| Europium | 0 |
| Gadolinium | 0.03 |
| Gallium | 0 |
| Germanium | 0 |
| Gold | 0 |
| Hafnium | 0 |
| Holmium | 0 |
| Iodine | 0 |
| Iridium | 0 |
| Iron | 600 |
| Lanthanum | 0.04 |
| Lead | 0.12 |
| Lithium | 0 |
| Lutetium | 0 |
| Magnesium | 49 |
| Manganese | 1.5 |
| Mercury | 0 |
| Molybdenum | 0.08 |
| Neodymium | 0.05 |
| Nickel | 0.8 |
| Niobium | 0 |
| Osmium | 0 |
| Palladium | 0 |
| Phosphorus | 0 |
| Platinum | 0 |
| Potassium | 0 |
| Praseodymium | 0 |
| Rhenium | 0 |
| Rhodium | 0 |
| Rubidium | 0.02 |
| Ruthenium | 0 |
| Samarium | 0 |
| Selenium | 0 |
| Silver | 0 |
| Sodium | 0 |
| Strontium | 0.1 |
| Tantalum | 0 |
| Tellurium | 0 |
| Thallium | 0 |
| Thorium | 0.03 |
| Thulium | 0 |
| Tin | 0 |
| Titanium | 0 |
| Tungsten | 0 |
| Uranium | 0 |
| Vanadium | 0 |
| Ytterbium | 0 |
| Yttrium | 0.05 |
| Zinc | 0 |
| Zirconium | 0 |

TABLE 11
AFTER REACTION (duplicate)

| Element | Ppm |
|---|---|
| Aluminum | 390, 310 |
| Antimony | 0, 0 |
| Arsenic | 0, 0 |
| Barium | 21, 18 |
| Beryllium | 0.04, 0.06 |
| Bismuth | 0, 0 |
| Boron | 0, 0 |
| Bromine | 0, 0 |
| Cadmium | 0, 0 |
| Calcium | 390, 270 |
| Cerium | 4.8, 3.5 |
| Cesium | 0.09, 0.08 |
| Chromium | 0.42, 0.33 |
| Cobalt | 0.21, 0.19 |
| Copper | 0.9, 0.8 |
| Dysprosium | 0.09, 0.06 |
| Erbium | 0.03, 0.02 |
| Europium | 0.05, 0.03 |
| Gadolinium | 0.28, 0.17 |
| Gallium | 0, 0 |
| Germanium | 0.03, 0 |
| Gold | 0, 0 |
| Hafnium | 0, 0 |
| Holmium | 0, 0 |
| Iodine | 0, 0 |
| Iridium | 0, 0 |
| Iron | 250, 240 |
| Lanthanum | 2.5, 1.8 |
| Lead | 0.51, 0.41 |
| Lithium | 0.5, 0.5 |
| Lutetium | 0, 0 |
| Magnesium | 31, 28 |
| Manganese | 0.74, 0.37 |
| Mercury | 0, 0 |
| Molybdenum | 0.17, 0.14 |
| Neodymium | 1.5, 1.0 |
| Nickel | 0.7, 0.5 |
| Niobium | 0.03, 0.02 |
| Osmium | 0, 0 |
| Palladium | 0, 0 |
| Phosphorus | 59, 36 |
| Platinum | 0, 0 |
| Potassium | 160, 120 |
| Praseodymium | 0.34, 0.24 |
| Rhenium | 0, 0 |
| Rhodium | 0, 0 |
| Rubidium | 0.77, 0.63 |
| Ruthenium | 0, 0 |
| Samarium | 0.28, 0.18 |
| Selenium | 0, 0 |
| Silver | 0, 0 |
| Sodium | 0, 0 |
| Strontium | 15, 12 |
| Tantalum | 0, 0 |
| Tellurium | 0, 0 |
| Thallium | 0, 0 |
| Thorium | 0.36, 0.26 |
| Thulium | 0, 0 |
| Tin | 0, 0 |
| Titanium | 3.4, 2.7 |
| Tungsten | 0, 0 |
| Uranium | 0.03, 0.02 |
| Vanadium | 0, 0 |
| Ytterbium | 0.02, 0 |
| Yttrium | 0.31, 0.19 |
| Zinc | 0, 0 |
| Zirconium | 0.05, 0.07 |

As shown by the data presented in Tables 10 and 11, differences in the elemental makeup of coal before and after being processed within the reactor indicate that an enhanced exothermic reaction has occurred. For example, common beta decay products such as lead showed an increase (0.12 ppm to 0.41 and 0.51 ppm). Additionally, as another example, Magnesium showed a decrease (49 ppm to 31 and 28 ppm) while Aluminum showed an increase (250 ppm to 310 and 390 ppm), which would be expected following a beta decay reaction involving the heavier isotopes of Magnesium

### Example 7

A baseline level of ambient radiation was measured while the reactor was out of operation. A digital Geiger counter (CGA-07) was calibrated using a combination of certified radioactive sources, as provided by the manufacturer of the equipment. At a distance of 3 meters from the reactor, the reading was 3.75 μSv/hr, which is equivalent to 32,850 μSv/year, which is equivalent to 3,285 mrem/year, an amount below the 5,000 mrem/year defined by the Nuclear Regulatory Commission (NRC) as a maximum annual exposure dosage for workers exposed to radioactive environments.

### Example 8

A baseline level of ambient radiation was measured while the reactor was out of operation. A digital Geiger counter (CGA-07) was calibrated using a combination of certified radioactive sources, as provided by the manufacturer of the equipment. At a distance of 3 meters from the reactor, the reading was 0.091 μSv/hr, which is equivalent to 797 μSv/year, which is equivalent to 79.7 mrem/year, an amount below the annual median dose in the United States, considered to be 310 mrem/year by the Nuclear Regulatory Commission (NRC) as an annual accumulated dose for an average person.

### Example 9

Radiation levels were measured during startup operation of the reactor (powered using natural gas) using the same equipment as in Example 8. Measurements were taken lateral and superior to the equipment, with the upper portion of the reactor left uncovered. The reading obtained was 0.108 μSv/hr, which is equivalent to 946.1 μSv/year, which is equivalent to 94.6 mrem/year. Discounting the baseline radiation of 79.7 mrem/year, the measured startup radiation is 14.9 mrem/year, an amount below the 100 mrem/year of additional radiation accepted by the Nuclear Regulatory Commission (NRC) as an annual accumulated dose for an average person.

### Example 10

Radiation levels were measured during base operation mode of the reactor (powered using natural gas plus 5 pounds of Illinois coal No. 6) using the same equipment as in Example 8. Measurements were taken lateral and superior to the equipment, with the upper portion of the reactor left uncovered. The reading obtained was 0.141 μSv/hr, which is equivalent to 1235.2 μSv/year, which is equivalent to 123.5 mrem/year. Discounting the baseline radiation of 79.7 mrem/year, the measured base operation mode radiation is 43.8 mrem/year, an amount below the 100 mrem/year of additional radiation accepted by the Nuclear Regulatory Commission (NRC) as an annual accumulated dose for an average person.

### Example 11

Radiation levels were measured during an overloaded operation mode of the reactor (powered using natural gas plus 5 pounds of Illinois coal No. 6 plus direct addition of CO₂ into reaction chamber) using the same equipment as in Example 8. Measurements were taken lateral and superior to the equipment, with the upper portion of the reactor left uncovered. The reading obtained was 0.191 μSv/hr, which is equivalent to 1673 μSv/year, which is equivalent to 167.3 mrem/year. Discounting the baseline radiation of 79.7 mrem/year, the measured base operation mode radiation is 87.6 mrem/year, an amount below the 100 mrem/year of additional radiation accepted by the Nuclear Regulatory Commission (NRC) as an annual accumulated dose for an average person.

### Example 12

Radiation levels were measured during a self-sustained operation mode of the reactor (powered using 5 pounds of Illinois coal No. 6 with natural gas flow cut off) using the same equipment as in Example 8. Measurements were taken lateral and superior to the equipment, with the upper portion of the reactor left uncovered. The reading obtained was 0.158 μSv/hr, which is equivalent to 1384 μSv/year, which is equivalent to 138.4 mrem/year. Discounting the baseline radiation of 79.7 mrem/year, the measured base operation mode radiation is 58.7 mrem/year, an amount below the 100 mrem/year of additional radiation accepted by the Nuclear Regulatory Commission (NRC) as an annual accumulated dose for an average person. The radiation measurements from Examples 9-12 are plotted against temperature measured within the reactor in FIG. 8. As shown, at higher temperatures of operation, the amount of measured ionizing radiation increases.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A reactor for transforming an organic fuel into thermal energy and radioactive species, comprising:
a reaction chamber;
a heat source in communication with the reaction chamber;
an air source in communication with the reaction chamber; and
a bed of catalytic media located within the reaction chamber so as to receive heat from the heat source and airflow from the air source, the bed of catalytic media being configured to generate highly reactive species upon interaction with heat and air;
wherein the catalytic media and highly reactive species are configured to interact with the organic fuel so as to induce an enhanced exothermic reaction within the reaction chamber, the enhanced exothermic reaction causing the emanation of ionizing radiation from the reactor.

2. The reactor of claim 1, further comprising an elevated support for holding the organic matter, the elevated support being locatable within the reaction chamber so as to position the organic matter a distance above the bed of catalytic media when the catalytic media is suspended by air flowing through the media.

3. The reactor of claim 1, wherein the ionizing radiation comprises beta particles.

4. The reactor of claim 1, wherein the ionizing radiation comprises alpha-particles.

5. The reactor of claim 1, wherein the ionizing radiation comprises gamma rays.

6. The reactor of claim 1, wherein the ionizing radiation is about 0.1 μSv per hour to about 5 μSv per hour at a distance of about 5 feet to about 10 feet from the reactor system.

7. The reactor of claim 1, wherein the ionizing radiation is about 5 μSv per hour to about 15 μSv per hour at a distance of about 5 feet to about 10 feet from the reactor system.

8. The reactor of claim 1, wherein the ionizing radiation is about 15 μSv per hour to about 25 μSv per hour at a distance of about 5 feet to about 10 feet from the reactor system.

9. The reactor of claim 1, wherein the enhanced exothermic reaction comprises a decay reaction resulting in the emanation of beta particles.

10. The reactor of claim 1, wherein a highly reactive environment within the reaction chamber induces the formation of heavy electrons and protons.

11. The reactor of claim 10, wherein at least a portion of the heavy electrons and protons react to form neutrons.

12. The reactor of claim 11, wherein at least a portion of the neutrons are captured by atoms of the organic fuel.

13. The reactor of claim 12, wherein at least a portion of the atoms of the organic fuel undergo beta decay by increasing in the number of protons and emitting beta radiation.

14. The reactor system of claim 1, wherein the catalytic media are selected from silica sand, silica gel, hydroxylbastnasite, alumina, and combinations thereof.

15. The reactor system of claim 1, wherein the highly reactive species include heavy electrons, protons, and hydroxyl radicals.

16. A power generation system, comprising:
a reactor including:
a reaction chamber;
a heat source in communication with the reaction chamber;
an air source in communication with the reaction chamber; and
a bed of catalytic media located within the reaction chamber so as to receive heat from the heat source and airflow from the air source, the bed of catalytic media being configured to generate highly reactive species upon interaction with heat and air;
wherein the catalytic media and highly reactive species are configured to interact with the organic fuel so as to induce an enhanced exothermic reaction within the reaction chamber, the enhanced exothermic reaction causing the emanation of ionizing radiation from the reactor;
a heat exchanger thermally coupled to the reaction chamber; and
a power generation unit operably coupled with the heat exchanger and configured to convert radioactive species or electromagnetic energy into work or stored energy.

17. A method for converting organic fuel into thermal energy and radioactive species, the method comprising:
providing a reactor comprising:
a reaction chamber;
a heat source in communication with the reaction chamber;
an air source in communication with the reaction chamber; and
a bed of catalytic media located within the reaction chamber so as to receive heat from the heat source and airflow from the air source, the bed of catalytic media being configured to generate highly reactive species upon interaction with heat and air;
wherein the catalytic media and highly reactive species are configured to interact with the organic fuel so as to induce an enhanced exothermic reaction within the reaction chamber, the enhanced exothermic reaction causing the emanation of ionizing radiation from the reactor;
introducing an organic fuel and airflow into the reaction chamber so as to interact with a catalytic media and generate a highly reactive environment within the reaction chamber, the highly reactive environment inducing an enhanced exothermic reaction within the reaction chamber, the enhanced exothermic reaction causing the emanation of ionizing radiation from the reactor.

18. The method of claim 17, wherein the enhanced exothermic reaction comprises a decay reaction resulting in the emanation of beta particles.

19. The method of claim 17, wherein the highly reactive environment includes an electrostatic field configured to generate heavy electrons within the reaction chamber.

20. The method of claim 19, wherein at least a portion of the heavy electrons react with protons to form neutrons, and wherein at least a portion of the neutrons are captured by atoms of the organic fuel to drive beta decay reactions within the organic fuel.
